(19) United States
(12) Patent Application Publication
(10) Pub. No.: US 2003/0123137 A1
(43) Pub. Date: Jul. 3, 2003

(54) Optical in-line amplifier and wavelength-division multiplexer

(76) Inventor: Takeshi Ota, Tokyo (JP)

Correspondence Address: NOTARO AND MICHALOS, 100 DUTCH HILL ROAD, SUITE 110, ORANGEBURG, NY, 10962-2100, US

(21) Appl. No.: 10/326,254

(22) Filed: Dec. 19, 2002

(30) Foreign Application Priority Data
Dec. 26, 2001 (JP) 2001-394016

(51) Int. Cl. H01S 3/00

(52) U.S. Cl. 359/341.1

(57) ABSTRACT

An optical in-line amplifier and a wavelength-division multiplexer suitable for a fiber-optic network that performs bi-directional transmission over a single optical fiber while using different wavelengths for each direction. By performing wavelength routing using three port devices, optical signals for each direction are separated and extracted. Subsequently, the signals are multiplexed and amplified together with a fiber amplifier. The amplified signals are once again routed to separate and extract the optical signals for each direction and to guide them in the proper direction.

### BACKGROUND OF THE INVENTION

1. Field of the Invention

The present invention relates to an optical in-line amplifier and a wavelength-division multiplexer used in an in-line amplifier for fiber-optic communications. The present invention particularly relates to an optical in-line amplifier and a wavelength-division multiplexer suitable for a communication method performing bi-directional transmission over a single optical fiber.

2. Description of the Related Art

FIG. 10 shows conventional optical in-line amplifiers employed as single-direction amplifiers. A node 111 transmits an optical signal 117 along an optical fiber 115. An optical in-line amplifier 113 converts the optical signal 117 into an amplified optical signal 118 and transmits the signal to an opposing node 112. An optical signal 119 is transmitted from the opposing node 112 along an optical fiber 116. The optical signal 119 is converted to an amplified optical signal 120 by an optical in-line amplifier 114 and transmitted to the first node 111. While erbium-doped fiber amplifiers are the most popular type of optical in-line amplifier, semiconductor laser amplifiers, Raman amplifiers, and the like can also be used. An optical isolator for preventing parasitic oscillations (a device that allows light transmission in a specific direction only) is commonly provided in all of these optical in-line amplifiers to ensure that amplification is performed only in a single direction.

Conventional wavelength-division multiplexers use thin-film filter type wavelength-division multiplexers, such as those shown in FIGS. 11A and 11B. Normally, thin-film filters are not used in direct relation with optical in-line amplifiers. However, the description of the present invention will focus on those types of optical in-line amplifiers that include thin-film filters as components.

As shown in FIG. 11A, a conventional wavelength-division multiplexer employing thin-film filters is configured of three-port devices 100a through 100d connected in tandem. FIG. 11B shows the construction of one of these three-port devices 100. The three-port device 100 comprises a common port optical fiber 101, a transmission port optical fiber 102, a reflection port optical fiber 103, collimator lenses 104 and 106, and a thin-film filter 105. Light from the optical fiber 101 of the common port passes through the collimator lens 104 and shines on the thin-film filter 105. The thin-film filter 105 allows only light of a specific wavelength (λ) to pass. Light of the specific wavelength (λ) is guided through the collimator lens 106 to the optical fiber 102 of the transmission port. Light of all wavelengths other than the specific wavelength (λ) is reflected by the thin-film filter 105 back through the collimator lens 104 and guided to the optical fiber 103 of the reflection port. By configuring the thin-film filter type wavelength-division multiplexer of FIG. 11A with these three-port devices 100a through 100d connected in tandem, only specific wavelengths λ1 through λ4 are selectively outputted via the transmission port of each three-port filter.

In the three-port devices of FIG. 11B, a portion of the light of wavelength λ that should pass through the thin-film filter 105 instead is reflected and guided to the reflection port optical fiber 103. This phenomenon of guiding unwanted light is called crosstalk. The ratio of crosstalk to the original light is known as isolation. For example, 20 dB of isolation indicates that 1/100^{th} of the original light (λ) emitted from the common port optical fiber 101 is guided to the reflection port optical fiber 103.

When light is introduced via the optical fiber 102 of the three-port device, as shown in FIG. 12, a reflected light 107 including crosstalk light scatters into free space. Accordingly, light emitted from the transmission port optical fiber 102 that is of a wavelength capable of passing through the thin-film filter is guided to the common port optical fiber 101, but almost no crosstalk is guided to the reflection port optical fiber 103, resulting in an extremely high isolation.

### SUMMARY OF THE INVENTION

In view of the foregoing, it is an object of the present invention to provide a bi-directional optical in-line amplifier capable of being used in a transmission system performing fiber-optic communications over a single optical fiber, and thereby capable of reducing the costs from those typically required for laying two optical fibers and providing two in-line amplifiers in a conventional in-line amplification system. These objects and others will be attained by the construction described within the scope of the claims.

Next, the principles of the invention will be described. In a transmission system that employs different wavelengths to perform bi-directional communications on a single optical fiber, the system can distinguish the directions of the optical signals based on their wavelengths. Using this property, the present invention performs wavelength routing with optical in-line amplifiers and a wavelength-division multiplexer in order to insert optical signals on their correct route after separating and amplifying the signals traveling in both directions. As a result, this single-fiber bi-directional transmission system can perform appropriate optical amplification while separately routing optical signals traveling in both directions. The present invention can also amplify signals of both directions together using a single optical amplifier, thereby reducing the number of required optical amplifiers.

### BRIEF DESCRIPTION OF THE DRAWINGS

In the drawings:

FIG. 1 is an explanatory diagram showing an optical in-line amplifier according to a first embodiment of the present invention;

FIG. 2 is an explanatory diagram showing an optical in-line amplifier according to a second embodiment of the present invention;

FIG. 3 is a graph showing the relationships of wavelengths when amplifying and relaying optical signals with multiple wavelengths;

FIG. 4 is an explanatory diagram showing a wavelength division multiplexer according to a third embodiment of the present invention;

FIG. 5 is an explanatory diagram showing a linked optical communication network comprising combinations of the optical in-line amplifiers and wavelength-division multiplexers according to the present invention;

FIG. 6 is an explanatory diagram showing a wavelength division multiplexer according to a fourth embodiment of the present invention;

FIG. 7 is an explanatory diagram showing a wavelength division multiplexer according to a fifth embodiment of the present invention;

FIG. 8 is an explanatory diagram showing an optical in-line amplifier according to a sixth embodiment of the present invention;

FIG. 9 is an explanatory diagram showing the function of an interleaver;

FIG. 10 is an explanatory diagram showing an optical transmission network using conventional optical in-line amplifiers;

FIG. 11A illustrates a conventional wavelength-division multiplexer using conventional thin-film filter type three-port devices;

FIG. 11B is an explanatory diagram showing the construction and behavior of a conventional thin-film filter type three-port device; and

FIG. 12 is an explanatory diagram showing the detailed behavior of the three-port device.

### DESCRIPTION OF THE PREFERRED EMBODIMENTS

An optical in-line amplifier and a wavelength-division multiplexer according to preferred embodiments of the present invention will be described while referring to the accompanying drawings.

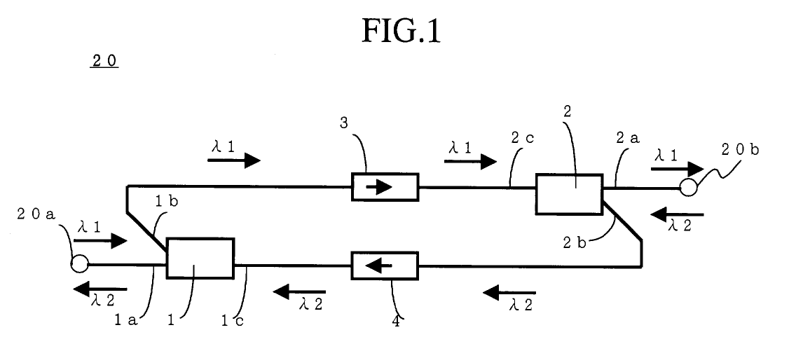

FIG. 1 shows an optical in-line amplifier 20 according to a first embodiment of the present invention. The optical in-line amplifier 20 includes bi-directional transmission ports 20a and 20b. The transmission ports 20a and 20b are connected to three-port devices 1 and 2 via common ports 1a and 2a, respectively. Of light inputted via the common port 1a, the three-port device 1 reflects the wavelength λ1 (1530 nm) and passes the wavelength λ2 (1550 nm). Of light inputted via the common port 2a, the three-port device 2 reflects the wavelength λ2 and passes the wavelength λ1. The optical in-line amplifier 20 is also provided with two C-band erbium-doped fiber amplifiers 3 and 4. C-band indicates the wavelength range of approximately 1525-1560 nm. Therefore, the amplifiers 3 and 4 can amplify light at a wavelength in the range of 1525-1560 nm.

An optical signal of wavelength λ1 inserted into the common port 1a is transferred to a reflection port 1b of the three-port device 1. After being amplified by the amplifier 3, the signal is transmitted to the common port 2a via a transmission port 2c of the three-port device 2. An optical signal of wavelength λ2 injected into the common port 2a is transferred to a reflection port 2b of the three-port device 2. After being amplified by the fiber amplifier 4, the signal is transmitted to the common port 1a via a transmission port 1c of the three-port device 1.

With this construction, the optical in-line amplifier of the present invention can perform bi-directional transmission over a single optical fiber using differing wavelengths such as the wavelength λ1 (1530 nm) for one direction and the wavelength λ2 (1550 nm) for the other direction.

One feature of the present invention shown in FIG. 1 is connecting the output of the fiber amplifier 3 to the transmission port 2c of the three-port device 2. The level of the signals is increased after amplification by the optical amplifiers. The level of the optical signal of wavelength λ1 inserted in the transmission port 2c is greater by 20 dB or more than the optical signal of wavelength λ2 added to the common port 2a. For this reason, a small amount of crosstalk may occur. This crosstalk will not pose any problems, however, as an extremely large isolation (50 dB or greater) can be obtained between the transmission port 2c and reflection port 2b as described in the related art.

While the wavelength λ1 is set to 1530 nm and the wavelength λ2 is set to 1550 nm in the embodiment described above, these wavelengths can be set to differing values, such as 1570 nm for the wavelength λ1 and 1590 nm for the wavelength λ2. In this case, the optical amplifiers can be replaced with an L-band erbium-doped fiber amplifier. L-band indicates a wavelength in the range of 1565-1605 nm, enabling the L-band erbium-doped fiber amplifier to amplify light within this wavelength range. It is also possible to use a wavelength from the ITU grid prepared for a 100 GHz (0.8 nm) interval or a 200 GHz (1.6 nm) interval for use in dense wavelength-division multiplexing (DWDM).

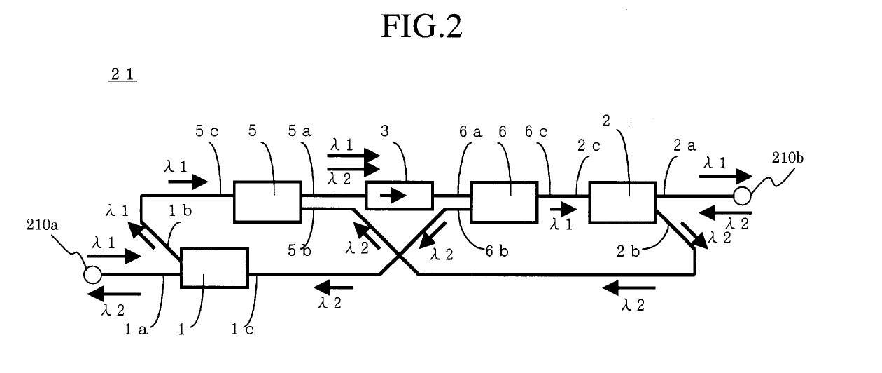

FIG. 2 shows an optical in-line amplifier 21 according to a second embodiment of the present invention. The optical in-line amplifier of the second embodiment employs only a single C-band erbium-doped amplifier 3, while adding two new three-port devices 5 and 6. Both of the three-port devices 5 and 6 pass a wavelength λ1 (1530 nm) while reflecting a wavelength λ2 (1550 nm). The amplifier 3 can amplify signals for both the wavelength λ1 and wavelength λ2 together. In the single-fiber bi-directional transmission method for transmitting bi-directionally over a single optical fiber using differing wavelengths, the paths of the signals are predetermined for each wavelength. Accordingly, by performing wavelength routing to determine the routes of each wavelength it is possible to extract the signal for both directions, amplify both signals together, and reinsert the signals on their correct paths. The present embodiment employs this property.

As in the first embodiment, the optical in-line amplifier 21 includes bi-directional transmission ports 210a and 210b connected to common ports 1a and 2a of the three-port device 1 and three-port device 2, respectively. An optical signal of the wavelength λ1 (1530 nm) inserted into the common port 1a is guided to the reflection port 1b and transmitted to a transmission port 5c of the three-port device 5. Since the three-port device 5 passes the wavelength λ1, the optical signal of wavelength λ1 is transmitted to a common port 5a. Light of the wavelength λ2 (1550 nm) inserted into the common port 2a is guided to the reflection port 2b. This signal is subsequently transmitted to a reflection port 5b of the three-port device 5 and guided to the common port 5a. As a result, optical signals for both wavelengths λ1 and λ2 are multiplexed and transferred to the fiber amplifier 3, where they are amplified together. Next, the amplified optical signals of wavelengths λ1 and λ2 are guided to a common port 6a of a three-port device 6. Since the three-port device 6 reflects the wavelength λ2 and passes the wavelength λ1, the amplified optical signal of wavelength λ1 is guided to the common port 2a via a transmission port 6c of the three-port device 6 and the transmission port 2c of the three-port device 2. The amplified optical signal of wavelength λ2, on the other hand, is guided to the common port 1a via a reflection port 6b of the three-port device 6 and the transmission port 1c of the three-port device 1.

This construction achieves an optical in-line amplifier for single-fiber bi-directional communications using λ1 (1530 nm) for one direction and λ2 (1550 nm) for the other.

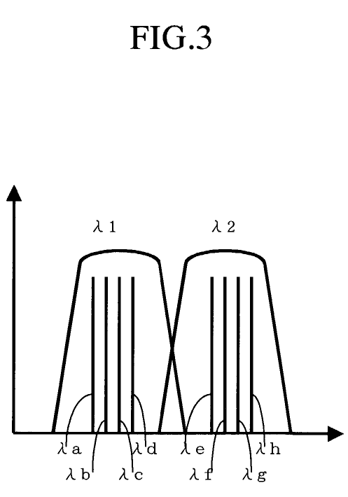

While each direction of communication is configured with a single wavelength in the above description, it is possible to use a plurality of wavelengths for each direction. As shown in FIG. 3, the pass wavelength of a three-port device has a certain wavelength range, enabling optical signals of a plurality of wavelengths to be provided within this range. For example, four wavelengths λa, λb, λc, and λd can be provided for one direction and another four λe, λf, λg, and λh for the other. This multi-wavelength configuration can also be applied to the first embodiment.

While an erbium-doped fiber amplifier is used as the optical amplifier in the embodiments described above, it is possible to use another type of optical amplifying method, a semiconductor laser amplifier, a Raman amp, or another rare-earth-doped fiber amplifier. Further, in the embodiment described above, a thin-film filter-type three-port device (a device for combining or separating optical signals of differing wavelengths) is used as the wavelength-division multiplexing device. However, another wavelength-division multiplexing device can be used.

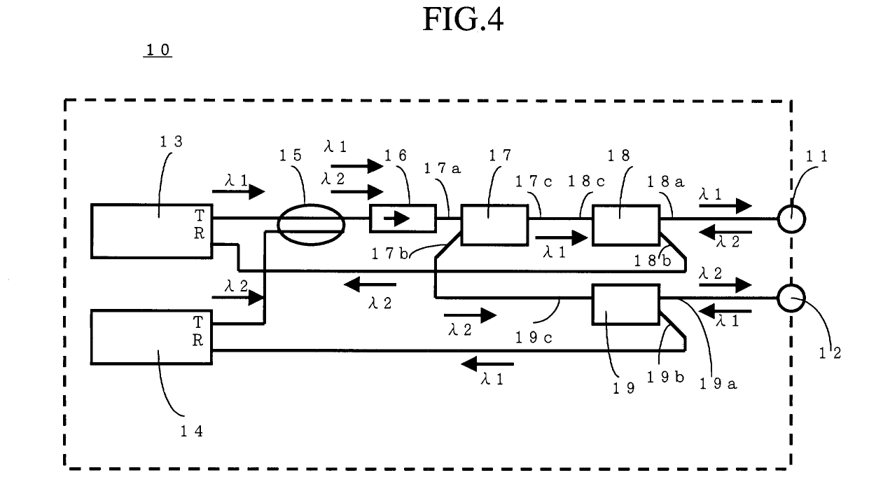

FIG. 4 shows a wavelength-division multiplexer 10 according to a third embodiment of the present invention. The wavelength-division multiplexer 10 comprises two bi-directional transmission ports 11 and 12. The bi-directional transmission port 11 is configured for a transmission wavelength λ1 (1530 nm) and reception wavelength λ2 (1550 nm), while the bi-directional transmission port 12 is configured for a transmission wavelength λ2 and a reception wavelength λ1.

The wavelength-division multiplexer 10 also includes optical transceivers 13 and 14, a fiber-optic coupler 15, a C-band erbium-doped fiber amplifier 16, and three-port devices 17-19. The optical transceiver 13 transmits an optical signal of the wavelength λ1, while the optical transceiver 14 transmits an optical signal of the wavelength λ2. The three-port device 17 and three-port device 18 pass the wavelength λ1 and reflect the wavelength λ2, while the three-port device 19 passes the wavelength λ2 and reflects the wavelength λ1.

An optical signal of the wavelength λ1 emitted from the optical transceiver 13 and an optical signal of the wavelength λ2 emitted from the optical transceiver 14 are multiplexed by the fiber-optic coupler 15 and amplified together by the fiber amplifier 16. The amplified optical signals are transmitted to the three-port device 17, by which the optical signal of λ1 is transferred to a transmission port 17c, while the optical signal of λ2 is transmitted to a reflection port 17b. The three-port device 18 performs wavelength-division multiplexing on the transmission and reception signals. Since signals of the wavelength λ2 are transmitted to the bi-directional transmission port 11 from another node, received optical signals of the wavelength λ2 are guided to a reflection port 18b of the three-port device 18 and transmitted to a reception port of the optical transceiver 13. Further, transmission signals of the wavelength λ1 passed through the transmission port 17c are transmitted to the other node via the bi-directional transmission port 11.

In contrast, the bi-directional transmission port 12 receives optical signals of the wavelength λ1 from the other node and transmits optical signals of the wavelength λ2 received from the optical transceiver 14 to the other node. An optical signal of the wavelength λ2 emitted from the optical transceiver 14 is amplified by the fiber amplifier 16 and outputted to the bi-directional transmission port 12 after passing through the reflection port 17b and a common port 19c of the three-port device 19.

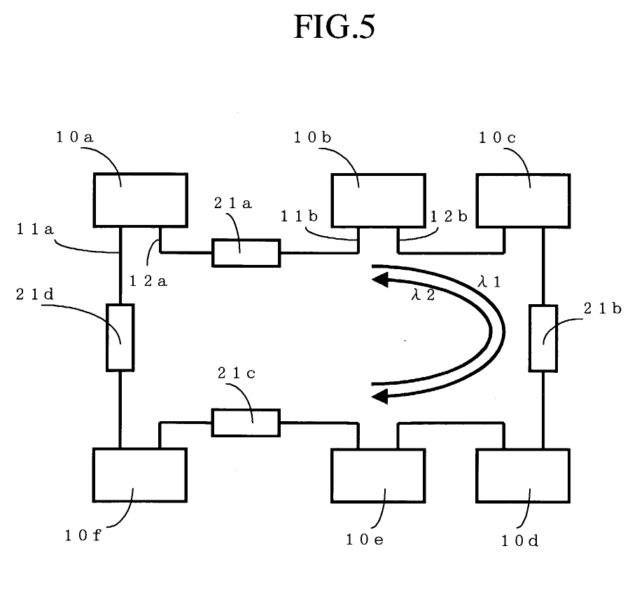

FIG. 5 shows an optical transmission network combining optical in-line amplifiers and wavelength-division multiplexers according to the present invention. The network includes wavelength-division multiplexers 10a-10f having the same construction as the wavelength-division multiplexer 10 shown in FIG. 4, and optical in-line amplifiers 21a-21d having the same construction as the optical in-line amplifier 21, shown in FIG. 2. By connecting the wavelength-division multiplexers 10a-10f in a ring configuration as shown in FIG. 5, a double ring network can be configured with a single optical fiber wherein the wavelength λ1 (1530 nm) is transmitted clockwise while the wavelength λ2 (1550 nm) is transmitted counterclockwise. The optical in-line amplifiers 21a-21d are provided in locations between multiplexers in which the distance is too long, in order to multiply and relay the signals.

In the wavelength-division multiplexer 10, it is also possible to use a WDM fiber-optic coupler or a three-port device in place of the fiber-optic coupler 15. Use of these devices can reduce signal loss. However, although some signal loss may occur when using the fiber-optic coupler 15, the C-band erbium-doped fiber amplifier 16 (booster amp) described above amplifies the optical signals to the saturation level of the fiber amplifier 16. Therefore, the actual loss in the fiber-optic coupler 15 is generally not a problem. The fiber-optic coupler is advantageous in that it costs less than a WDM fiber-optic coupler or a three-port device.

The construction described above has the remarkable effect of performing bi-directional transmission on two optical fibers using a single C-band erbium-doped fiber amplifier.

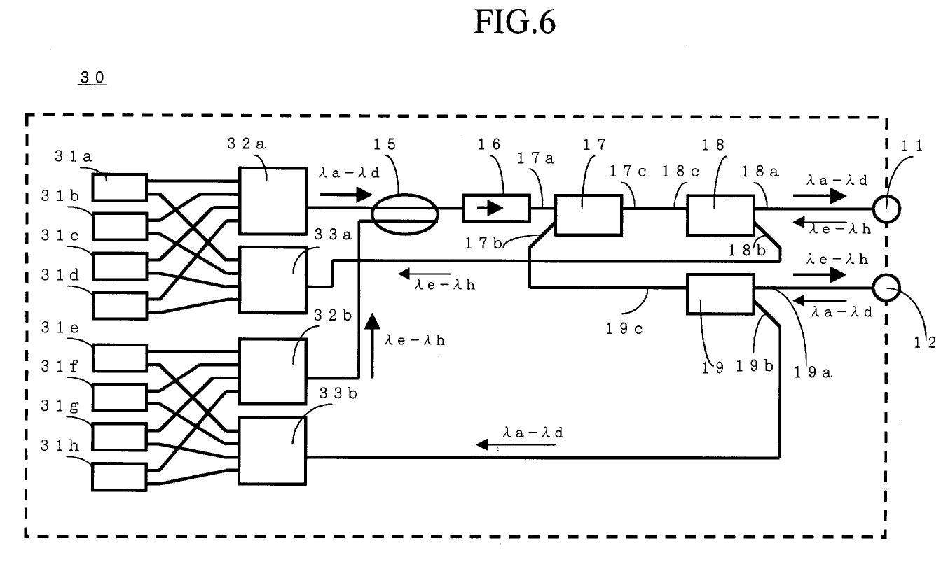

FIG. 6 shows a wavelength-division multiplexer 30 according to a fourth embodiment of the present invention. In the fourth embodiment, single fiber bi-directional transmission is conducted using four wavelengths for each transmission direction.

The wavelength-division multiplexer 30 of the present embodiment includes optical transceivers 31a-31h for generating optical signals of the wavelengths λa-λh. The relationship of the wavelengths λa-λh are as shown in FIG. 3. In addition, the wavelength-division multiplexer 30 comprises wavelength multiplexers 32a and 32b and wavelength demultiplexers 33a and 33b. Optical signals of the wavelengths λa-λd emitted from the optical transceivers 31a-31d are multiplexed by the wavelength multiplexer 32a. Similarly, optical signals of the wavelengths λe-λh emitted from the optical transceivers 31e-31h are multiplexed by the wavelength multiplexer 32b. The optical signals for wavelengths λa-λh are further multiplexed by the fiber-optic coupler 15 and amplified simultaneously by the fiber amplifier 16. The optical signals of λa-λd are guided to the bi-directional transmission port 11 via the transmission port 17c of the three-port device 17 and a transmission port 18c of the three-port device 18, while optical signals of λe-λh are guided to the bi-directional transmission port 12 via the reflection port 17b and a transmission port 19a of the three-port device 19.

Optical signals of wavelengths λe-λh transmitted to the bi-directional transmission port 11 from another node are transferred to the wavelength demultiplexer 33a via the reflection port 18b of the three-port device 18. The wavelength demultiplexer 33a separates each wavelength and transmits them to the corresponding optical transceivers 31a-31d. Similarly, optical signals of the wavelengths λa-λd transferred to the optical in-line amplifier 21 from another node are transferred to the wavelength demultiplexer 33b via a reflection port 19b of the three-port device 19. The wavelength demultiplexer 33b separates each of the wavelengths and transfers them to their respective optical transceivers 31e-31h. In FIG. 6, thinner arrows are used to distinguish optical reception signals received via the bi-directional transmission ports 11 and 12 from optical transmission signals.

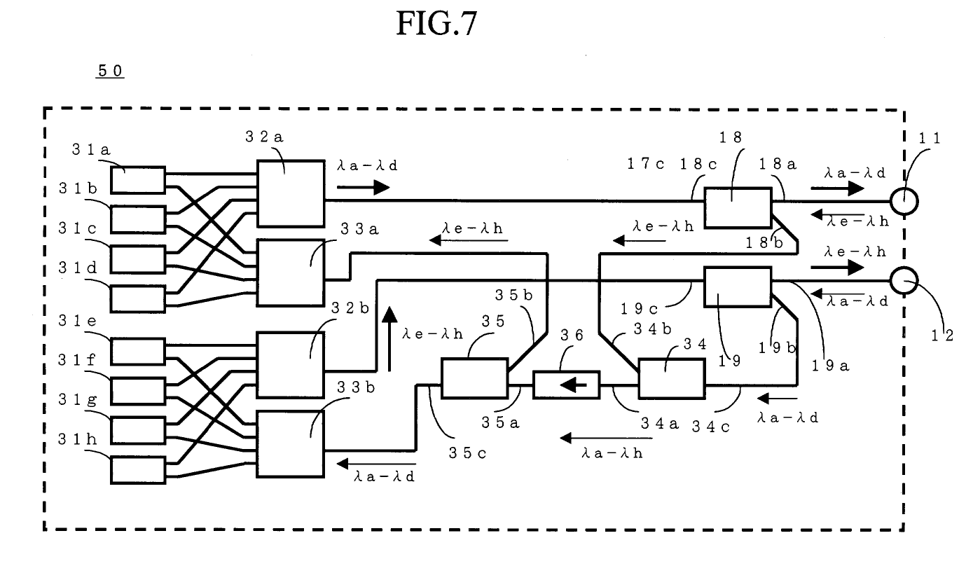

FIG. 7 shows a wavelength-division multiplexer 50 according to a fifth embodiment of the present invention. The fifth embodiment is similar to the fourth embodiment in that the wavelength-division multiplexer 50 performs single fiber bi-directional transmission using four wavelengths in each transmission direction. The point at which the fifth embodiment differs from the fourth embodiment is that the optical amplifier is used as a pre-amp rather than a booster amp. A booster amp increases the transmission power of the optical signal, while a pre-amp pre-amplifies received optical signals. The wavelength-division multiplexer 50 of the present embodiment is provided with three-port devices 34 and 35 in place of the fiber-optic coupler 15 and three-port device 17, and a C-band erbium-doped fiber amplifier 36. It is preferable to set different specifications for the amplifier 16 and the amplifier 36.

Optical signals of wavelengths λe-λh transmitted to the bi-directional transmission port 11 from another node are sent to a reflection port 34b of the three-port device 34 via the reflection port 18b. Optical signals of the wavelengths λa-λd transmitted to the bi-directional transmission port 12 from another node are sent to a transmission port 34c of the three-port device 34 via the reflection port 19b. As a result, optical signals of wavelengths λa-λh received by the bi-directional transmission ports 11 and 12 are amplified together by the fiber amplifier 36. The amplified signals are separated by the three-port device 35 into optical signal group of wavelengths λa-λd and optical signal group of wavelengths λe-λh. These optical wavelength groups are transmitted to the wavelength demultiplexer 33b and wavelength demultiplexer 33a, respectively.

Optical transmission signals of wavelengths λa-λd multiplexed by the wavelength multiplexer 32a are transmitted to the other node via the three-port device 18 and bi-directional transmission port 11. Similarly, optical transmission signals of wavelengths λe-λh multiplexed by the wavelength multiplexer 32b are transmitted to the other node via the three-port device 19 and the bi-directional transmission port 12.

It is also possible to configure a wavelength-division multiplexer comprising both the booster amp of the fourth embodiment and the pre-amp of the fifth embodiment. Further, the optical in-line amplifier of the second embodiment can be provided in this wavelength-division multiplexer. In this case, a single amplifier is made to function as a pre-amp and booster amp. In the configuration in FIG. 7, four wavelengths are employed for each transmission direction. However, the number of wavelengths can be set arbitrarily beginning from one wavelength for each direction.

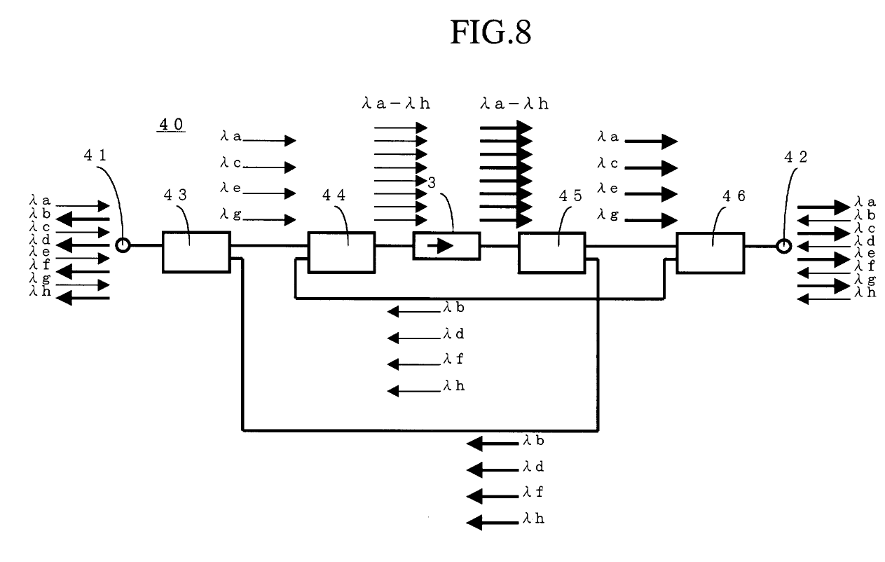

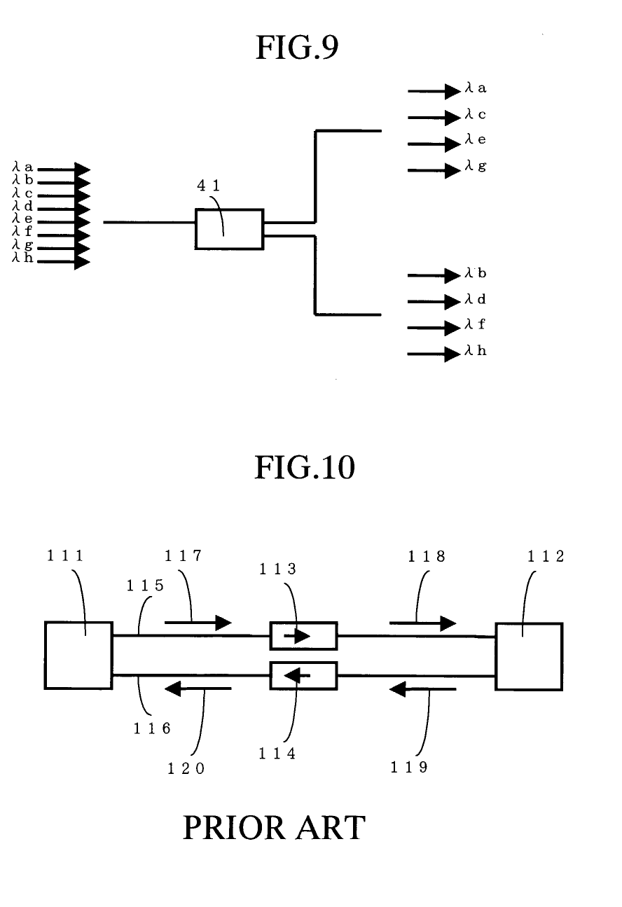

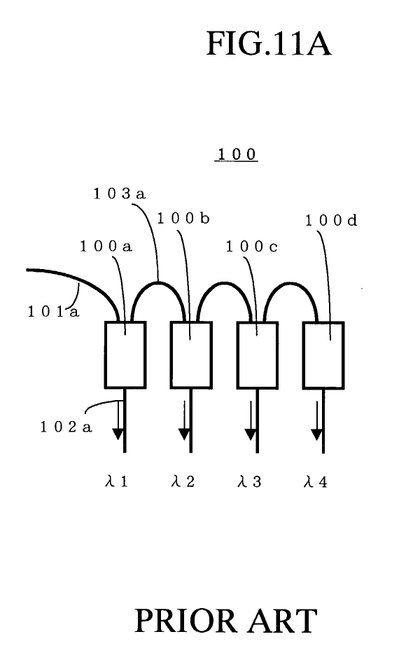

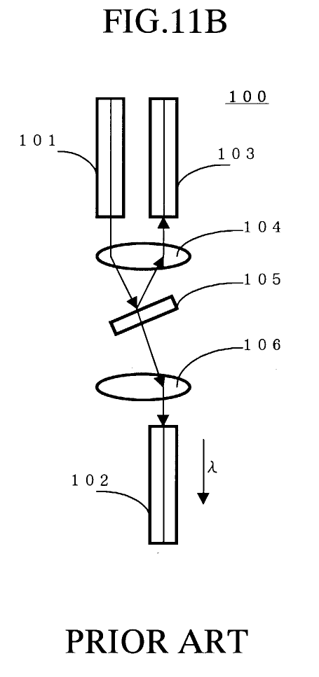

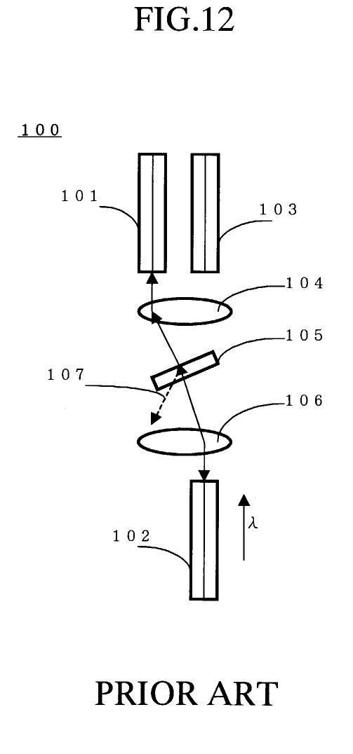

FIG. 8 shows an optical in-line amplifier 40 according to a sixth embodiment of the present invention. This optical in-line amplifier employs an interleaver in place of the three-port device with a thin-film filter. An interleaver 43 operates as shown in FIG. 9 for alternately separating and guiding optical signals of the wavelengths λa-λh to two separate ports. Hence, the interleaver 43 sends optical signals of wavelengths λa, λc, λe, and λg to one port and signals of λb, λd, λf, and λh to the other port.

As shown in FIG. 8, the optical in-line amplifier 40 includes four interleavers 43, 44, 45, and 46. As in the second embodiment, the optical in-line amplifier 40 also includes a C-band erbium-doped fiber amplifier 3. Optical signals of wavelengths λa, λc, λe, and λg inserted into a port 41 of the optical in-line amplifier 40 are transmitted to the C-band erbium-doped fiber amplifier 3 via the interleavers 43 and 44. The amplified optical signals of wavelengths λa, λc, λe, and λg are then transferred to a port 42 on the opposite end of the port 41 via interleavers 45 and 46. Optical signals of wavelengths λb, λd, λf, and λh inputted into the port 42 of the optical in-line amplifier 40 are transmitted to the C-band erbium-doped fiber amplifier 3 via the interleavers 46 and 44. The amplified optical signals of wavelengths λb, λd, λf, and λh are then transferred to the port 41 via interleavers 45 and 43. The inputted optical signals and amplified optical signals are differentiated in FIG. 8 by different arrow thicknesses. Hence, the optical in-line amplifier 40 functions to amplify optical signals inputted via the port 41 and transmit the amplified signals to the port 42, and to amplify optical signals inputted via the port 42 and transmit the amplified signals to the port 41.

It is also possible to create a wavelength-division multiplexer such as that shown in the fourth embodiment using interleavers.

The present invention can provide an optical in-line amplifier capable of relaying and amplifying optical signals in a fiber-optic communication network for performing bi-directional communications over a single optical fiber. The present invention can also provide a wavelength-division multiplexer capable of performing bi-directional transmission over a single optical fiber.

What is claimed is:

1. An optical in-line amplifier used in a fiber-optic communication network performing bi-directional transmission over a single optical fiber using different wavelengths for each direction, the optical in-line amplifier comprising:
a first bi-directional transmission port;
a second bi-directional transmission port;
a first thin-film filter type three-port device having a common port, a transmission port, and a reflection port, the common port being connected to the first bi-directional transmission port;
a second thin-film filter type three-port device having a common port, a transmission port, and a reflection port, the common port being connected to the second bi-directional transmission port;
a first optical amplifier for amplifying optical signals transmitted from the first bi-directional transmission port via the common port of the first thin-film filter type three-port device and the reflection port of the same three-port device; and
a second optical amplifier for amplifying optical signals transmitted from the second bi-directional transmission port via the common port of the second thin-film filter type three-port device and the reflection port of the same three-port device,
wherein the optical signal amplified by the first optical amplifier is outputted to the common port of the second thin-film filter type three-port device via the transmission port of the same, and the optical signal amplified by the second optical amplifier is outputted to the common port of the first thin-film filter type three-port device via the transmission port of the same.

2. An optical in-line amplifier used in a fiber-optic communication network performing bi-directional transmission over a single optical fiber using different wavelengths for each direction, the optical in-line amplifier comprising:
a first wavelength-division multiplexer for extracting optical signals of a first wavelength;
a second wavelength-division multiplexer for extracting optical signals of a second wavelength;
a third wavelength-division multiplexer for combining optical signals of the first and second wavelengths;
a single optical amplifier for amplifying the optical signals of the first and second wavelengths combined by the third wavelength-division multiplexer;
a fourth wavelength-division multiplexer for separating the amplified optical signals of the first and second wavelengths and sending the optical signal of the first wavelength to the second wavelength-division multiplexer and the optical signals of the second wavelength to the first wavelength-division multiplexer.

3. An optical in-line amplifier used in a fiber-optic communication network performing bi-directional transmission over a single optical fiber using different wavelengths for each direction, the optical in-line amplifier comprising:
a first wavelength-division multiplexer for extracting a group of optical signals of a plurality of wavelengths within a first group of wavelengths;
a second wavelength-division multiplexer for extracting a group of optical signals of a plurality of wavelengths within a second group of wavelengths;
a third wavelength-division multiplexer for combining groups of optical signals having wavelengths within the first and second groups of wavelengths;
a single optical amplifier for amplifying the optical signals of the first and second groups of wavelengths combined by the third wavelength-division multiplexer;
a fourth wavelength-division multiplexer for separating the amplified optical signals of the first and second groups of wavelengths and sending the optical signals of the first group of wavelengths to the second wavelength-division multiplexer and the optical signals of the second group of wavelengths to the first wavelength-division multiplexer.

4. A wavelength-division multiplexer used in a fiber-optic communication network performing bi-directional transmission over a single optical fiber using different wavelengths for each direction, the wavelength-division multiplexer comprising:
first and second transmission/reception ports;
a first optical transceiver for generating optical signals of a first wavelength;
a second optical transceiver for generating optical signals of a second wavelength;
a single optical amplifier;
a single wave combining device; and
first through third wavelength-division multiplexers,
wherein the wave combining device combines optical signals received from the first and second optical transceivers; the optical amplifier amplifies the optical signals of both the first and second wavelengths together; the first wavelength-division multiplexer separates the optical signals of the first wavelength and second wavelength and transmits the signals to the first and second transmission/reception ports via the second and third wavelength-division multiplexers.

5. A wavelength-division multiplexer used in a fiber-optic communication network performing bi-directional transmission over a single optical fiber using different wavelengths for each direction, the wavelength-division multiplexer comprising:
first and second transmission/reception ports;
a first group of optical transceivers for generating optical signals of a plurality of wavelengths within a first group of wavelengths;
a second group of optical transceivers for generating optical signals of a plurality of wavelengths within a second group of wavelengths;
a single optical amplifier;
a single wave combining device; and
first through third wavelength-division multiplexers, wherein the wave combining device combines optical signals received from the first and second optical transceivers; the optical amplifier amplifies the optical signal groups of both the first and second groups of wavelengths together; the first wavelength-division multiplexer separates the optical signal groups of the first group of wavelengths and the second group of wavelengths and transmits the optical signal groups to the first and second transmission/reception ports via the second and third wavelength-division multiplexers.

6. A wavelength-division multiplexer used in a fiber-optic communication network performing bi-directional transmission over a single optical fiber using different wavelengths for each direction, the wavelength-division multiplexer comprising:
first and second transmission/reception ports;
a first optical transceiver for generating optical signals of a first wavelength;
a second optical transceiver for generating optical signals of a second wavelength;
a single optical amplifier;
a single wave combining device; and
first through third wavelength-division multiplexers,
wherein the wave combining device combines optical signals received from the first and second transmission/reception ports; the optical amplifier amplifies the optical signals of both the first and second wavelengths together; the first wavelength division multiplexer separates the optical signals of the first wavelength and second wavelength and transmits the signals to the first and second optical transceivers via the second and third wavelength-division multiplexers.

7. A wavelength-division multiplexer used in a fiber-optic communication network performing bi-directional transmission over a single optical fiber using different wavelengths for each direction, the wavelength-division multiplexer comprising:
first and second transmission/reception ports;
a first group of optical transceivers for generating optical signals of a plurality of wavelengths within a first group of wavelengths;
a second group of optical transceivers for generating optical signals of a plurality of wavelengths within a second group of wavelengths;
a single optical amplifier;
a single wave combining device; and
first through third wavelength-division multiplexers,
wherein the wave combining device combines optical signals received from the first and second transmission/reception ports; the optical amplifier amplifies the optical signal groups of both the first and second groups of wavelengths together; the first wavelength-division multiplexer separates the optical signal groups of the first group of wavelengths and the second group of wavelengths and transmits the optical signal groups to the first and second optical transceivers via the second and third wavelength-division multiplexers.
